(19) United States
(12) Patent Application Publication
(10) Pub. No.: US 2008/0238219 A1
(43) Pub. Date: Oct. 2, 2008

(54) ROTOR AND METHOD FOR MANUFACTURING THE SAME

(75) Inventors: Akinori Hoshino, Nisshin-shi (JP); Tetsuya Morita, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/043,501

(22) Filed: Mar. 6, 2008

(30) Foreign Application Priority Data
Mar. 27, 2007 (JP) 2007-081271

(51) Int. Cl. H02K 1/28; H02K 15/02; H02K 1/27

(52) U.S. Cl. 310/42; 310/261; 29/598

(57) ABSTRACT

A rotor includes a rotor core made of a magnetic material, a receiving portion provided at the rotor core, a magnet accommodated in the receiving portion, a first end plate provided at a first end portion of the rotor core, a second end plate provided at a second end portion of the rotor core, a tightening device tightening integrally the rotor core, the first end plate, and the second end plate, an opening portion provided at one of the first end plate and the second end plate so as to communicate with the receiving portion, and a magnet fixing member formed by a coagulation of a thermoplastic resin that is injected from the opening portion so as to fix the magnet to the receiving portion.

### CROSS REFERENCE TO RELATED APPLICATIONS

This application is based on and claims priority under 35 U.S.C. §119 to Japanese Patent Application No. 2007-081271, filed on Mar. 27, 2007, the entire content of which is incorporated herein by reference.

### FIELD OF THE INVENTION

This invention generally relates to a rotor of a motor and a method for manufacturing the same.

### BACKGROUND

A known rotor of a permanent magnet motor is formed by a rotor core that is made up of laminated plates, and the like and that includes permanent magnet receiving holes into which respective permanent magnets are inserted to be fixed.

JP2004147451A discloses a rotor of a permanent magnet motor in which a rotor core and permanent magnets are fixed to each other in the following way. That is, the permanent magnets are received in respective magnet receiving holes formed at the rotor core (i.e., magnetic core) that is made up of laminated plates, and the like. The rotor core accommodating the permanent magnets is placed at a lower mold that constitutes a forming mold and is then covered by a frame, and further, an upper mold that also constitutes the forming mold so as to achieve a mold clamping. The forming mold is filled with a synthetic resin in a molten state to thereby achieve an integral molding of the rotor core and the permanent magnets by means of the synthetic resin.

In addition, JP2006246560A discloses a rotor of a permanent magnet motor of which manufacturing method includes an adhesive filling process, a magnet inserting process, a mounting process, an inverted preheating process, an upright preheating process, and a thermal curing process. The adhesive filling process includes injecting an adhesive into magnet receiving holes provided at a rotor core that is made up of laminated plates. One end of each of the magnet receiving holes positioned at a lower side of the rotor core is covered by a rotor shaft. The magnet inserting process includes inserting permanent magnets into respective magnet receiving holes after the adhesive is injected into the magnet receiving holes. The mounting process includes mounting an end plate onto an upper surface of the rotor core so that the end plate is fixed to the rotor core while covering the magnet receiving holes. The inverted preheating process includes maintaining the rotor at a temperature higher than an ambient temperature but lower than a curing temperature of the adhesive in a state where the rotor is positioned upside down from a position of the rotor during the adhesion filling process. The upright preheating process includes maintaining the rotor at a preheat temperature in a state where the rotor is positioned in a direction same as that during the adhesive filling process. The thermal curing process includes heating the rotor at the curing temperature of the adhesive.

According to the rotor of the permanent magnet motor disclosed in JP2004147451A, the forming mold is required for the integral molding of the frame, the rotor core, and the permanent magnets by means of the synthetic resin. Thus, a necessity of a process after the molding such as a deburring may induce an increase in cost.

In addition, according to the rotor of the permanent magnet motor disclosed in JP2006246560A, when each of the permanent magnets is inserted into the magnet receiving hole where the adhesive has already been injected, the adhesive may overflow from the magnet receiving hole.

Further, in the cases where magnetic steel plates are laminated at a core receiving portion of the rotor shaft, the magnetic steel plates may expand in a lamination direction thereof (i.e., cushion effect) or the adhesive may enter between the magnetic steel plates, which leads to a change in height of the laminated magnetic steel plates in the lamination direction thereof. The expansion or change in height of the magnetic steel plates in the lamination direction may cause a deterioration of the assembly performance or the damage of the magnetic steel plates at a time of running the motor, and the like.

After the mounting process in which the end plate is mounted onto the rotor core so as to be fixed thereto while covering the magnet receiving holes, the rotor is maintained at a temperature higher than an ambient temperature but lower than the curing temperature of the adhesive in a state where the rotor is positioned upside down from a position of the rotor during the adhesive filling process, and then the rotor is maintained at a preheat temperature in a state where the rotor is returned to be positioned in a direction same as that during the adhesive filling process. Afterwards, the rotor is maintained at the curing temperature of the adhesive. Therefore, an up and down direction of the rotor needs to be changed through the processes, which may lead to complicated equipment and an increase in equipment cost. Further, a wide range of temperature control (i.e., control of several temperatures) is required depending on the process, which may result in a complicated process control.

Thus, a need exists for a rotor and a method for manufacturing the same which is not susceptible to the drawback mentioned above.

### SUMMARY OF THE INVENTION

According to an aspect of the present invention, a rotor includes a rotor core made of a magnetic material, a receiving portion provided at the rotor core, a magnet accommodated in the receiving portion, a first end plate provided at a first end portion of the rotor core, a second end plate provided at a second end portion of the rotor core, a tightening device tightening integrally the rotor core, the first end plate, and the second end plate, an opening portion provided at one of the first end plate and the second end plate so as to communicate with the receiving portion, and a magnet fixing member formed by a coagulation of a thermoplastic resin that is injected from the opening portion so as to fix the magnet to the receiving portion.

According to another aspect of the present invention, a method for manufacturing a rotor includes a magnet receiving process for accommodating a magnet into a receiving portion formed at a rotor core that accommodates the magnet, a mounting process for arranging a first end plate at a first end of the rotor core that accommodates the magnet and for arranging a second end plate at a second end of the rotor core, a tightening process for tightening the first end plate, the rotor core, and the second end plate by a tightening device, and a magnet fixing process for fixing the magnet to the rotor core by means of a magnet fixing member that is formed by a coagulation of a thermoplastic resin injected from an opening portion provided at one of the first end plate and the second end plate so as to communicate with the receiving portion.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross-sectional view illustrating a structure of a motor according to a first embodiment of the present invention;

FIG. 2 is a diagram illustrating a rotor when viewed from a direction of an end plate according to the first embodiment of the present invention;

FIG. 3 is a diagram illustrating an opening portion formed at the end plate and communicating with a magnet receiving portion according to the first embodiment of the present invention;

FIG. 4 is a cross-sectional view taken along the line IV-IV in FIG. 3;

FIG. 5 is a diagram illustrating opening portions formed at the end plate and communicating with the magnet receiving portion according to a second embodiment of the present invention;

FIG. 6 is a cross-sectional view taken along the line VI-VI in FIG. 5;

FIG. 7 is a diagram illustrating cutout portions formed at an outer circumferential side of the end plate according to a third embodiment of the present invention; and

FIG. 8 is a flowchart illustrating a manufacturing method of a rotor according to the first to third embodiments of the present invention.

### DETAILED DESCRIPTION

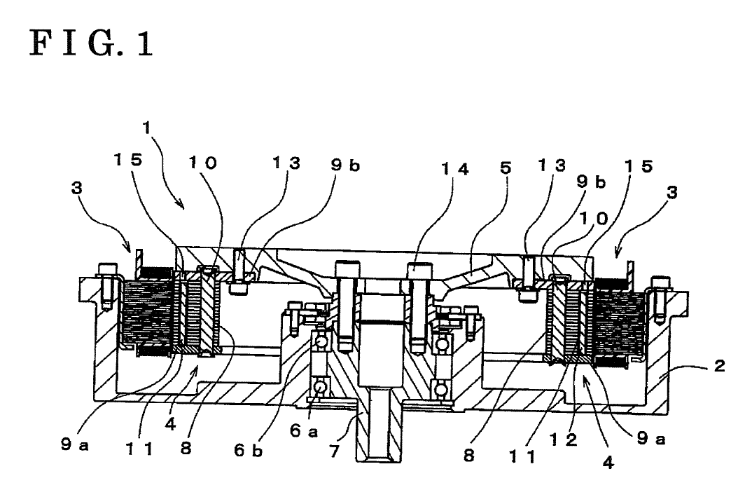

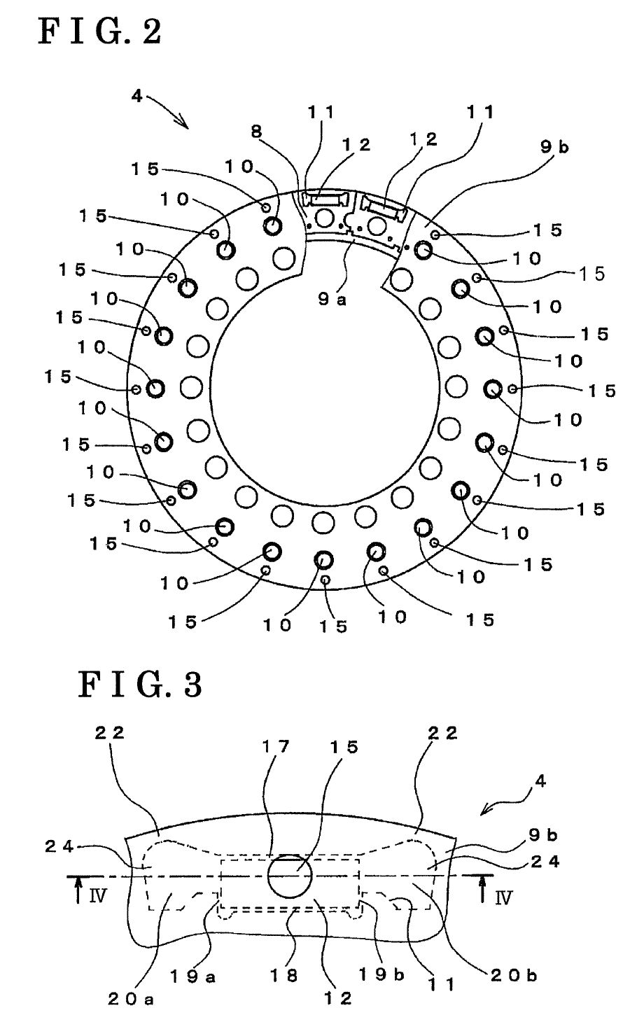

Embodiments of the present invention will be explained with reference to the attached drawings. Same symbols or reference numbers throughout the drawings according to first to third embodiments show substantially the same or equivalent component parts. Thus, a detailed explanation of such parts will be omitted in the second and third embodiments and only a different point will be mainly explained. The first embodiment will be explained with reference to FIGS. 1 and 2. FIG. 1 is a cross-sectional view illustrating a structure of a motor 1. FIG. 2 is a diagram of a rotor 4 when viewed from a direction of an end plate 9b with a condition that a portion of the end plate 9b is omitted.

As illustrated in FIG. 1, the motor 1 such as a brushless type motor includes a housing 2, a stator 3, the rotor 4, and a flywheel 5. The housing 2 having a cylindrical shape with a bottom portion includes a boss portion at a center. Bearings 6a and 6b are provided at an inner surface of the boss portion so as to support a shaft 7. That is, the shaft 7 is supported at the housing 2 so as to be rotatable relative thereto. The flywheel 5 is attached to the shaft 7 via six fitting bolts 14, for example, on an axially opposite side (i.e., upper side in FIG. 1) from an end portion where the shaft 7 and the housing 2 are attached to each other (i.e., lower side in FIG. 1). The rotor 4 is arranged between the housing 2 and the flywheel 5 so as to be coaxial therewith and rotatable relative to the housing 2 that is supported at the shaft 7. The stator 3 is arranged, facing the rotor 4 as illustrated in FIG. 1.

The rotor 4 is mounted via a bolt 13 to the flywheel 15, which is fixed to the shaft 7 via the fitting bolts 14 so as to be coaxial therewith. A rotor core 8, which constitutes the rotor 4, is formed by a lamination of multiple silicon steel plates in an axial direction of the shaft 7. The rotor core 8 includes multiple magnet receiving portions 11, each serving as a receiving portion, into which respective magnets 12 are accommodated. Further, the rotor core 8 is sandwiched from axially both ends by end plates 9a and 9b serving as first and second end plates, respectively. As illustrated in FIGS. 1 and 2, while or after a pressure is applied from the end plate 9a and/or the end plate 9b towards the shaft 7, fixing pins 10 each serving as a tightening device are press fitted to the rotor core 8, the end plate 9a, and the end plate 9b and thereafter axially both ends of each fixing pin 10 are riveted, thereby securing the end plates 9a and 9b to the rotor core 8. Then, a heated thermoplastic resin is injected from a nozzle (not shown) into opening portions 15 provided at the end plate 9b and communicating with the respective magnet receiving portions 11. As a result, the heated thermoplastic resin flowing into the magnet receiving portions 11 coagulates to form a magnet fixing member 16 by means of which the magnets 12 is fixed or secured to the respective magnet receiving portions 11. The rotor 4 is accommodated in the housing 2 in such a way as not to axially and circumferentially contact an inner wall of the housing 2 by means of the shaft 7.

FIG. 3 illustrates one of the opening portions 15 formed at the end plate 9b and facing the magnet receiving portion 11. Each of the magnets 12 is accommodated in each of the magnet receiving portions 11 while keeping an outer diameter side gap 17, an inner diameter side gap 18, and tangential gaps 19a and 19b with the magnet receiving portion 11. In order to ease the flow of the thermoplastic resin into the outer diameter side gap 17, the opening portion 15 is formed in such a way to face or overlap the outer diameter side gap 17. Accordingly, the thermoplastic resin heated to its molten temperature or more is injected into the outer diameter side gap 17 from the opening portion 15. Further, the thermoplastic resin having sufficiently low viscosity flows into the inner diameter side gap 18, the tangential gaps 19a and 19b, and/or wide gaps 20a and 20b in addition to the outer diameter side gap 17. The magnet 12 is securely fixed or secured to the magnet receiving portion 11 by means of the magnet fixing member 16 formed by a coagulation of the thermoplastic resin.

The opening portion 15 is formed so as to face or overlap the outer diameter side gap 17 and the magnet 12 as mentioned above. However, the position of the opening portion 15 is not limited to the above and may be formed so as to overlap the outer diameter side gap 17, the inner diameter side gap 18, and the magnet 12, to overlap the tangential gap 19a or 19b, the outer diameter side gap 17, and the magnet 12, or the like all of which can still achieve an effect of the opening portion 15.

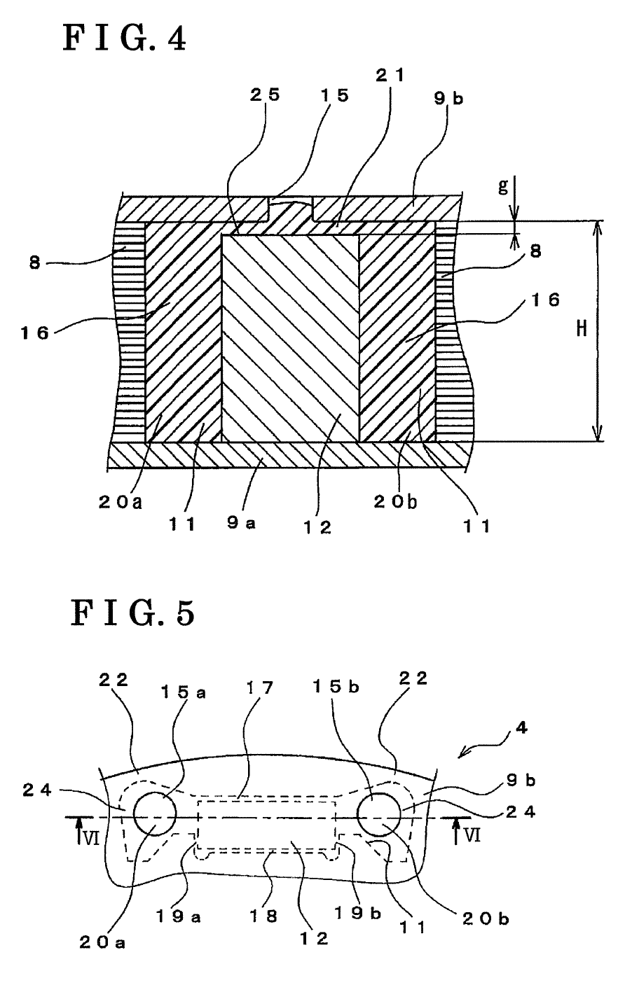

FIG. 4 is a cross-sectional view taken along the line IV-IV in FIG. 3. In view of variation in a height H of the rotor core 8 formed by integrally laminated silicon steel plates, a height g is defined in the magnet receiving portion 11 when the magnet 12 is accommodated therein.

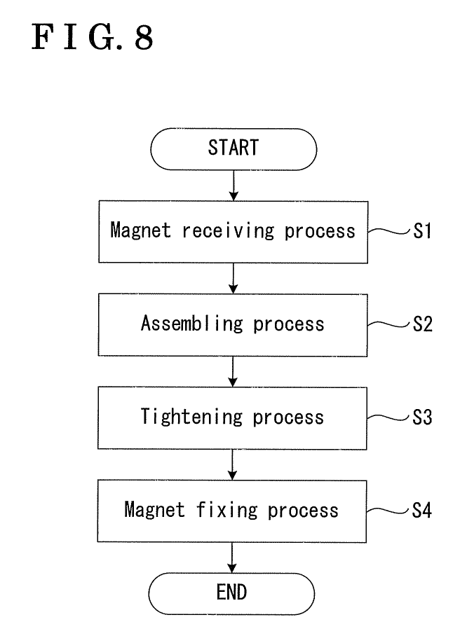

A method for manufacturing the rotor 4 includes a magnet receiving process S1, an assembling process S2, a tightening process S3, and a magnet fixing process S4 as illustrated by a flowchart in FIG. 8. The motor 1 is manufactured by incorporating such rotor 4. The magnet receiving process S1 includes molding the rotor core 8 made of a magnetic material and bringing the magnets 12 to be accommodated into the respective magnet receiving portions 11 formed at the rotor core 8. The assembling process S2 includes mounting the end plate 9a onto axially one end (i.e., first end portion) of the rotor core 8 accommodating the magnets 12 and mounting the end plate 9b onto axially the other end (i.e., second end portion) of the rotor core 8. The tightening process S3 includes integrally tightening the end plate 9a, the rotor core 8, and the end plate 9b by means of the fixing pins 10. The magnet fixing process S4 includes injecting the thermoplastic resin from the opening portions 15 provided at the end plate 9b and communicating with the respective magnet receiving portions 11 so as to fix the magnets 12 to the rotor core 8 by means of the magnet fixing member 16.

Since the rotor 4 is constituted by the rotor core 8 including the magnet receiving portions 11 accommodating the respective magnets 12, the opening portions 15 provided at the end plate 9b so as to communicate with the respective magnet receiving portions 11, and the magnet fixing member 16 formed by the coagulation of the thermoplastic resin injected from the opening portions 15 so as to fix the magnets 12 to the rotor core 8, a forming mold or die is not required and therefore a burr is prevented. As a result, the motor 1 can be provided at a low cost. In addition, while manufacturing the rotor 4 of the motor 1, a change in the up and down direction of the rotor 4 is not required or a wide range of temperature control is not necessary, which leads to a decrease in cost of equipment and parts.

Further, each of the opening portions 15 overlaps fully or partially the gap 17 formed between the magnet 12 and the magnet receiving portion 11 accommodating the magnet 12. Thus, the thermoplastic resin injected from the opening portion 15 can securely flow into the gap 17 positioned in the vicinity of the opening portion 15. Since a portion of the opening portion 15 is opened on the upper surface of the magnet 12, the thermoplastic resin is securely injected to the upper surface of the magnet 12. As a result, the magnet 12 is securely fixed to the magnet receiving portion 11 by means of the magnet fixing portion 16.

After the magnet receiving process S1, the end plate 9a, the rotor core 8, and the end plate 9b are integrally tightened by means of the fixing pins 10. The magnet receiving portions 11 of the rotor core 8 are surrounded by the end plate 9a, the rotor core 8, and the end plate 9b, accordingly. Then, the thermoplastic resin is injected from the opening portions 15 into the respective magnet receiving portions 11 so that the magnets 12 are fixed to the rotor core 8 by means of the magnet fixing member 16. As a result, a forming mold and a deburring process are not required, which leads to a low cost rotor.

As illustrated in FIGS. 3 and 4, according to the aforementioned first embodiment, the thermoplastic resin flows into a narrow gap such as the outer diameter side gap 17 and then smoothly flows into a passage communicating with the wide gaps 20a and 20b. In addition, the thermoplastic resin is injected to the upper surface of the magnet 12 to thereby securely fixing the magnet 12 to the magnet receiving portion 11 by means of the magnet fixing member 16.

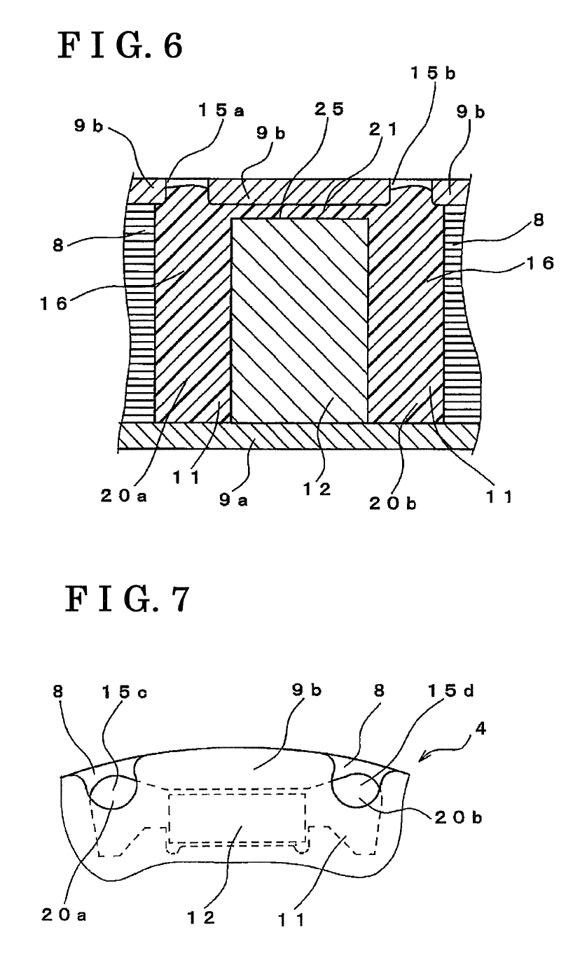

Next, a second embodiment of the present invention will be explained with reference to FIGS. 5 and 6. As illustrated in FIG. 5, the rotor 4 having multiple magnetic poles by accommodating the multiple magnets 12 includes narrow portions 22 each having a large magnetic resistance and formed between the adjacent magnets 12, respectively, at an outer circumferential portion of the rotor core 8. In addition, voids 24 each having a large magnetic resistance are also formed between the adjacent magnets 12, respectively, at an inner circumferential side relative to the narrow portions 22. Then, an opening portion 15a facing the wide gap 20a of the magnet receiving portion 11, and an opening portion 15b facing the wide gap 20b of the magnet receiving portion 11 are formed at the end plate 9b.

FIG. 6 is a cross-sectional view taken along the line VI-VI in FIG. 5. The thermoplastic resin injected from the nozzle equipped with heating means (not shown) simultaneously or separately through the opening portions 15a and 15b flows into the wide gaps 20a and 20b facing the openings 15a and 15b, respectively. The thermoplastic resin even having a low pressure (in a range from 2 MPa to 10 MPa, for example) easily flows into the gaps 20a and 20b since the gaps 20a and 20b are positioned at a lower side of the openings 15a and 15b.

A third embodiment of the present invention will be explained with reference to FIG. 7. FIG. 7 illustrates cutout portions 15c and 15d at an outer circumferential side of the end plate 9b so as to communicate with the magnet receiving portion 11. In the case of molding the end plate 9b including the cutout portions 15c and 15d at the circumferential side by means of a press working, the cutout portions 15c and 15d can be formed simultaneously at the time of a blanking process of the end plate 9b to thereby reduce the number of processes.

According to the aforementioned embodiments, the rotor core 8 is formed by a lamination of multiple silicon steel plates. However, the rotor core 8 is not limited to be formed thereby and may be made up of other magnetic materials such as a ferrite magnetic material integrally formed. In addition, the magnets 12 accommodated in the respective magnet receiving portions 11 may be magnetized before the magnets 12 are accommodated in the magnet receiving portions 11 so as to serve as permanent magnets beforehand, or may be magnetized after the magnets 12 are fixed to the respective magnet receiving portions 11 of the rotor core 8 by means of the magnet fixing member 16.

Further, according to the aforementioned embodiments, the opening portions 15, 15a, and 15b each has a round shape. Alternatively, the opening portions 15, 15a, and 15b each may have an elliptical shape, a rectangular shape, or a combined shape thereof. Further, according to the aforementioned embodiments, the number of openings facing each magnet receiving portion 11 is one or two. Alternatively, three or more openings may face each magnet receiving portion 11.

Furthermore, according to the aforementioned embodiments, the polyester hot-melt resin having a low viscosity is used as the thermoplastic resin. Alternatively, other types of thermoplastic resin may be used.

According to the aforementioned embodiments, the end plates 9a and 9b, and the rotor 4 including the rotor core 8 at which the magnet receiving portions 11 are formed while accommodating the respective magnets 12 are first assembled to one another. Then, the thermoplastic resin is injected from the opening portions 15, or 15a and 15b communicating with the respective magnet receiving portions 11 so that the magnets 12 are fixed to the respective magnet receiving portions 11 by means of the magnet fixing member 16 formed by the coagulation of the thermoplastic resin. In this case, the rotor core 8, the end plate 9a, and the end plate 9b collectively serve as a forming mold to thereby avoid a use thereof for the injection of the thermoplastic resin. As a result, a burr is prevented, thereby manufacturing a low cost motor.

In addition, the thermoplastic resin is injected into the rotor 4 in a state where the rotor core 8 and the end plates 9a and 9b are integrally tightened. Then, the magnets 12 are fixed to the respective magnet receiving portions 11 by means of the magnet fixing member 16. Therefore, magnetic steel plates constituting the rotor core 8 are prevented from expanding in a lamination direction thereof (i.e., cushion effect) or the adhesive is prevented from entering between the magnetic steel plates that leads to a change in height of the laminated magnetic steel plates in the lamination direction thereof. The deterioration of the assembly performance or the damage of the magnetic steel plates at a time of running the motor, and the like can be avoided.

Further, the change in position of the rotor 4 in the up and down direction through the manufacturing process or complicated temperature control is not required, which leads to a decrease in equipment cost, parts cost, or the like.

According to the aforementioned embodiments, the rotor 4 further includes the outer diameter side gap 17 formed between the receiving portion 11 and the magnet 12, and the opening portion 15 (or opening portions 15a and 15b) partially or fully opens towards the gap 17.

Accordingly, the thermoplastic resin injected from the opening portions 15, or 15a and 15b securely flows into the gaps 17, 18, 19a, and 19b formed between the magnet 12 and the magnet receiving portion 11 and positioned in the vicinity of the opening portions 15, or 15a and 15b. In addition, since a portion of the opening portion 15, or 15a and 15b opens, facing the upper surface of the magnet 12 so that the thermoplastic resin is securely injected to the upper surface of the magnet 12.

According to the aforementioned embodiments, the opening portion 15 (or opening portions 15a and 15b) fully opens towards the gap 17, 18, 19a, or 19b formed between the receiving portion 11 and the magnet 12 in a circumferential direction of the rotor core 8 or in a tangential direction of the magnet 12.

Accordingly, the cross section of a flow passage of the thermoplastic resin is widely secured and the thermoplastic resin is smoothly injected into the respective magnet receiving portions 11 to thereby reduce an injection time. In addition, since the injection pressure can be reduced, the thermoplastic resin is prevented from entering into the laminated steel plates to overflow to an outer peripheral side of the rotor core 8.

According to the aforementioned embodiments, the cutout portions 15c and 15d are formed at an outer circumferential side of one of the end plates 9a and 9b.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotor comprising:
a rotor core made of a magnetic material;
a receiving portion provided at the rotor core;
a magnet accommodated in the receiving portion;
a first end plate provided at a first end portion of the rotor core;
a second end plate provided at a second end portion of the rotor core;
a tightening device tightening integrally the rotor core, the first end plate, and the second end plate;
an opening portion provided at one of the first end plate and the second end plate so as to communicate with the receiving portion; and
a magnet fixing member formed by a coagulation of a thermoplastic resin that is injected from the opening portion so as to fix the magnet to the receiving portion.

2. A rotor according to claim 1, further comprising a gap formed between the receiving portion and the magnet, wherein the opening portion partially or fully opens towards the gap.

3. A rotor according to claim 2, wherein the opening portion fully opens towards the gap formed between the receiving portion and the magnet in a circumferential direction of the rotor core or in a tangential direction of the magnet.

4. A rotor according to claim 1, wherein the opening portion is equal to a cutout portion formed at an outer circumferential side of one of the first end plate and the second end plate.

5. A method for manufacturing a rotor comprising:
a magnet receiving process for accommodating a magnet into a receiving portion formed at a rotor core that accommodates the magnet;
a mounting process for arranging a first end plate at a first end of the rotor core that accommodates the magnet and for arranging a second end plate at a second end of the rotor core;
a tightening process for tightening the first end plate, the rotor core, and the second end plate by a tightening device; and
a magnet fixing process for fixing the magnet to the rotor core by means of a magnet fixing member that is formed by a coagulation of a thermoplastic resin injected from an opening portion provided at one of the first end plate and the second end plate so as to communicate with the receiving portion.
